(19) United States
(12) Patent Application Publication
(10) Pub. No.: US 2005/0012691 A1
(43) Pub. Date: Jan. 20, 2005

(54) Method for driving plasma display panel

(75) Inventors: Tsutomu Tokunaga, Yamanashi-ken (JP); Kazuaki Sakata, Yamanashi-ken (JP); Hideki Tanaka, Yamanashi-ken (JP); Hideto Nakamura, Yamanashi-ken (JP); Yoshichika Sato, Yamanashi-ken (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/891,125

(22) Filed: Jul. 15, 2004

(30) Foreign Application Priority Data
Jul. 17, 2003 (JP) 2003-198255

(51) Int. Cl. G09G 3/28

(52) U.S. Cl. 345/60

(57) ABSTRACT

A method for driving a plasma display panel which sets a pulse width of a first sustain pulse applied first of sustain pulses applied in a light emission sustain stage to be larger than a pulse width of at least one sustain pulse of sustain pulses applied after the first sustain pulse, and applies wall charge amount adjusting pulses having the same polarity as the sustain pulses simultaneously to respective row electrodes which form a pair immediately before the first sustain pulse is applied. An erroneous discharge can be prevented in the light emission sustain stage in each subfield.

### BACKGROUND OF THE INVENTION

1. Field of the Invention

The present invention relates to a driving method for driving a plasma display panel.

2. Description of the Related Art

FIG. 1 is a diagram showing the general configuration of a display device using a plasma display panel.

In FIG. 1, the plasma display panel (hereinafter called the “PDP”) 10 has row electrodes Y₁-Yₙ and Xₗ-Xₙ which make up row electrode pairs X, Y corresponding to respective rows (first to n-th rows) of one screen. The PDP 10 is also formed with column electrodes Z₁-Zₘ corresponding to respective columns (first to m-th columns) of one screen, which are arranged orthogonal to the row electrode pairs and across a dielectric layer and a discharge space, not shown. A discharge cell serving as a pixel is formed at the intersection of a pair of row electrodes (X, Y) with a column electrode Z.

Each discharge cell has only two states, “light emission” and “non-light emission” depending on whether or not a discharge occurs in the discharge cell. In other words, the discharge cell is capable of representing only two levels of luminance which are a minimum luminance (non-light emitting state) and a maximum luminance (light emitting state).

Thus, a driver 100 for driving the PDP 10, conducts a gradation driving scheme which employs a subfield method for providing halftone luminance levels corresponding to an input video signal (image signal) for the PDP 10 which has such light emitting elements.

The subfield method involves converting an input video signal into N-bit pixel data corresponding to each pixel, and dividing one field display period into N subfields corresponding to respective bit digits of the N bits. A display period of one field is divided into four subfields SF1-SF4, for example, as shown in FIG. 2. Each of the subfields is set the number of times of discharge generated corresponding to a weight assigned to each of the subfields (8, 4, 2, 1 in FIG. 2), so that the discharge is selectively generated only in subfields in accordance with the video signal. A halftone luminance corresponding to the video signal can be produced for each field by a total number of times the discharge is generated in the respective subfields.

A selective erasure addressing method is known as a method for driving a PDP to provide halftone images by use of the subfield method.

FIG. 3 is a timing chart showing applying timings at which the driver 100 applies a variety of driving pulses to the column electrodes and the row electrodes of the PDP 10 in one subfield in the gradation driving based on the selective erasure addressing method.

First, the driver 100 simultaneously applies a reset pulse RP_{X} of negative polarity to the row electrodes X₁-Xₙ, and a reset pulse RP_{Y} of positive polarity to the row electrodes Y₁-Yₙ (simultaneous reset stage Rc).

In response to the application of these reset pulses RP_{X} and RP_{Y}, all the discharge cells in the PDP 10 are discharged to uniformly form a predetermined amount of wall charge in each of the discharge cells. All the discharge cells are initially set once into a lit discharge cell state.

Next, the driver 100 converts the input video signal, for example, into 8-bit pixel data for each pixel. The driver 100 divides the pixel data for each bit digit to generate pixel data bits, and generates a pixel data pulse having a pulse voltage in accordance with the logical level of each of the pixel data bits. The driver 100 sequentially applies the column electrodes Z₁-Zₘ with the pixel data pulses DP₁-DPₙ, each of which has the pixel data pulses for one line (m) and corresponds to each of the first to n-th lines, as shown in FIG. 3. The driver 100 generates a pixel data pulse which is at high voltage when the pixel data bit is, for example, at logical level “1” and at low voltage (zero volt) when at logical level “0.” Further, the driver 100 generates a scanning pulse SP as shown in FIG. 3 at the timing at which each of the data pulses DP is applied, and sequentially applies this to the row electrodes Y₁-Yₙ (pixel data writing stage Wc).

A discharge occurs only in discharge cells at intersections of those row electrodes which have been applied with the scanning pulse SP and those column electrodes which have been applied with the pixel data pulses at high voltage (selective writing discharge) to erase wall charges remaining in these discharge cells. Thus, those discharge cells, which have been initialized to the lit discharge cell state in the simultaneous reset stage Rc, proceed to an unlit discharge cell state. On the other hand, those discharge cells which have been applied with the scanning pulse SP but also applied with low voltage image data pulses do not undergo the selective writing discharge, and remain in the initialized state in the simultaneous reset stage Rc, i.e., the lit discharge cell state.

Next, the driver 100 repeatedly applies a sustain pulse IP_{X} of positive polarity as shown in FIG. 3 to the row electrodes X₁-Xₙ, and repeatedly applies a sustain pulse IP_{Y} of positive polarity as shown in FIG. 3 to the row electrodes Y₁-Yₙ during a period in which the sustain pulse IP_{X} is not applied to the row electrodes X₁-Xₙ (light emission sustain stage Ic).

Those discharge cells in which the wall charge remains, i.e., only lit discharge cells discharge each time they are alternately applied with the sustain pulses IP_{X}, IP_{Y} (sustain discharge). In other words, only discharge cells which have been set into the lit discharge cell state in the pixel data writing stage Wc repeat the light emission associated with the sustain discharge by a number of times corresponding to the weight for each subfield to sustain the visual light emitting state. The number of times the sustain pulse IP_{X}, IP_{Y} is applied is the number of times which has been previously set in accordance with the weight assigned to each subfield.

For the sustain pulses IP_{X} and IP_{Y} in each subfield, as shown in FIG. 3, the first pulse of the sustain pulse IP_{X} is given the largest pulse width Ta, and each of the sustain pulses IP_{Y} and IP_{X} applied subsequent thereto is given a pulse width Tb smaller than the pulse width Ta of the first pulse. This is intended to prevent erroneous discharges due to discharge delays to stabilize the sustain discharge because priming particles produced by the reset discharge and addressing discharge decrease over time, and a larger amount of priming particles causes the discharge delays more frequently (for example, Japanese Patent No. 2674485).

Next, the driver 100 applies the row electrodes X₁-Xₙ with an erasure pulse EP as shown in FIG. 3 (erasure stage E). All the discharge cells are simultaneously erased or discharged to extinguish the wall charges remaining in the respective discharge cells.

A sequence of operations as described above is executed a plurality of times in one field to visually provide a halftone luminance corresponding to a video signal.

However, in a plasma display panel which is designed to start a discharge between a scanning electrode and an addressing electrode at a lower voltage by increasing a partial pressure of xenon, or narrowing down the opposing spacing between a column electrode (addressing electrode) and a row electrode (scanning electrode) which is applied with a scanning pulse, application of a sustain pulse having a wide pulse width causes a discharge that is produced between the row electrodes of those cells which have been set into the unlit discharge cell state in the pixel data writing stage Wc, resulting in a problem of an erroneous discharge which can occur in the light emission sustain stage Ic.

### SUMMARY OF THE INVENTION

It is an object of the present invention to provide a method for driving a plasma display panel which is capable of preventing an erroneous discharge in a light emission sustain stage.

A method for driving a plasma display panel according to the present invention produces a halftone image in accordance with an image signal, said plasma display panel having discharge cells at respective intersections of a plurality of row electrode pairs corresponding to display lines and a plurality of column electrodes arranged to cross said row electrode pairs, and the method comprises the steps of: dividing a display period of one field of the image signal into a plurality of subfields, in each of said subfields, executing a pixel data writing stage for sequentially applying a scanning pulse to one row electrode of said row electrode pair, and applying pixel data pulses corresponding to the image signal, to said column electrodes in order to generate a selective discharge for setting each of said discharge cells to one of a lit discharge cell state and an unlit discharge cell state, and a light emission sustain stage for applying said row electrode pairs with a sustain pulse by a number of times corresponding to a weight assigned to each of said subfields in order to generate a sustain discharge only in said discharge cells which are in the lit discharge cell state, and setting a pulse width of a first sustain pulse applied first of said sustain pulses applied in said light emission sustain stage so that the pulse width becomes larger than a pulse width of at least one sustain pulse of the sustain pulses applied after said first sustain pulse, and simultaneously applying wall charge amount adjusting pulses having the same polarity as said sustain pulses to said respective row electrodes which form a pair immediately before said first sustain pulse is applied.

### BRIEF DESCRIPTION OF THE DRAWINGS

FIG. 1 is a diagram showing a configuration of a display device using a PDP;

FIG. 2 is a diagram showing periods of four subfields in one field;

FIG. 3 is a diagram showing application timings at which a variety of pulses are applied to the PDP in one subfield;

FIG. 4 is a diagram showing pulses applied to respective row electrodes and column electrodes in a light emission sustain stage in one subfield as an embodiment of the present invention;

FIG. 5 is a diagram showing pulses applied to the respective row electrodes and column electrodes in the light emission sustain stage in one subfield as another embodiment of the present invention; and

FIG. 6 is a diagram showing pulses applied to the respective row electrodes and column electrodes in the light emission sustain stage in one subfield as a further embodiment of the present invention.

### DETAILED DESCRIPTION OF THE INVENTION

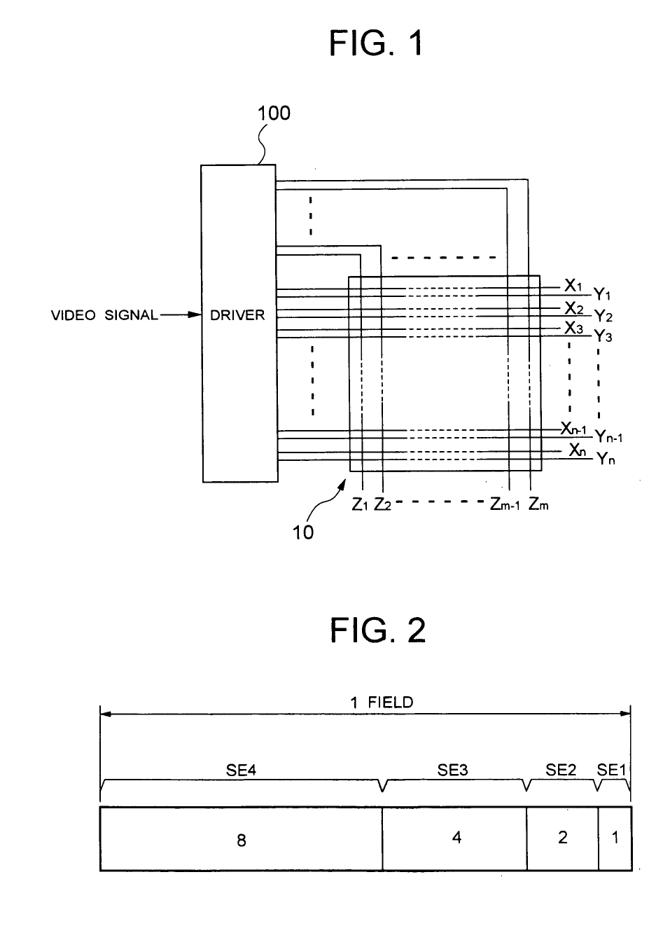

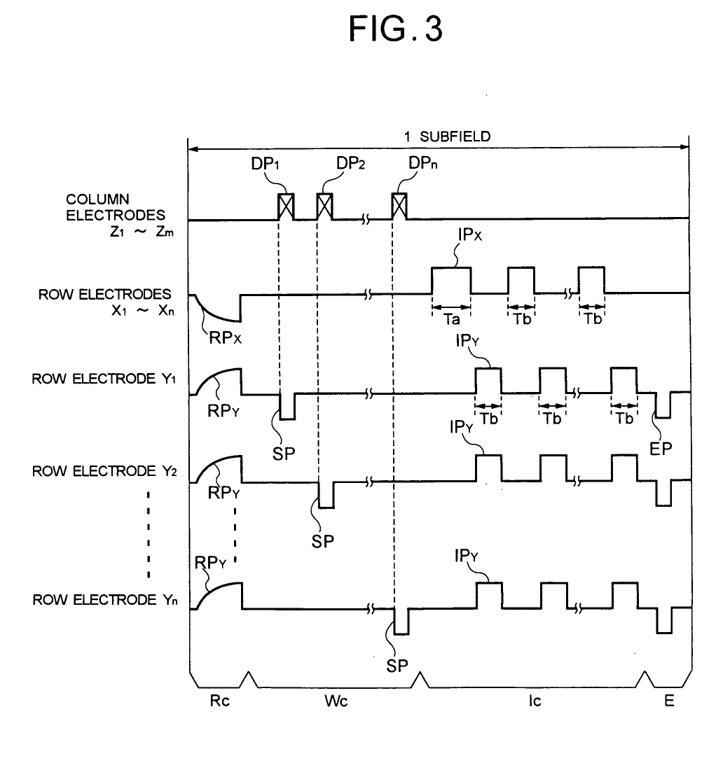

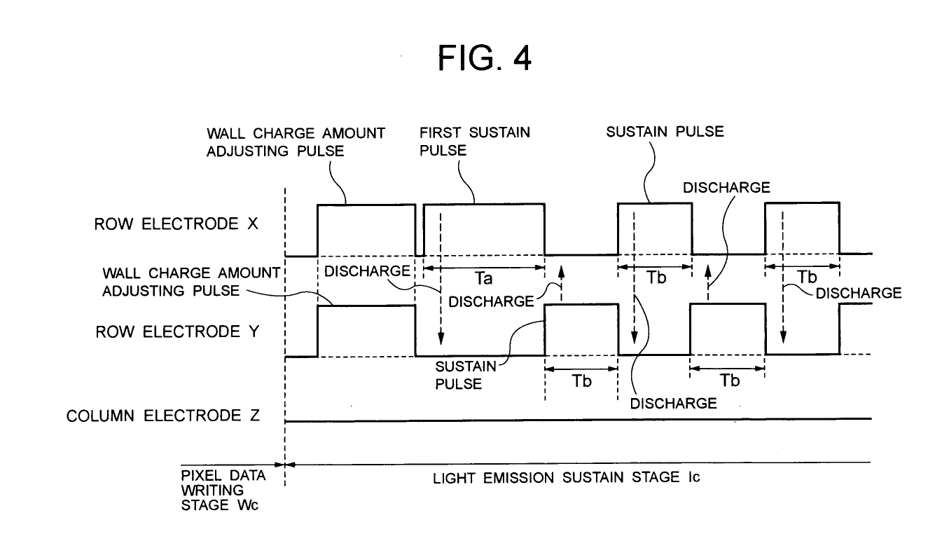

FIG. 4 shows pulses applied to row electrodes X, Y and a column electrode Z in a light emission sustain stage Ic in one subfield when a method for driving a plasma display panel according to the present invention is applied to the display device of FIG. 1. The row electrodes X, Y is one pair of row electrodes of row electrodes X₁-Xₙ, Y₁-Yₙ, and the column electrode Z is one of column electrodes Z₁-Zₘ.

In the light emission sustain stage Ic, wall charge amount adjusting pulses are applied simultaneously to the row electrodes X, Y. Specifically, the row electrodes X, Y are applied with the wall charge amount adjusting pulses which have the same polarity (positive polarity), the same voltage, and the same pulse width. The application of the wall charge amount adjusting pulses reduces the amount of wall charge formed on the column electrode Z. Even if a discharge occurs between the row electrode X or Y and the column electrode Z due to the application of the wall charge amount adjusting pulses, a large amount of wall charge will not be formed between the row electrodes X, Y because the row electrodes X, Y are at the same potential.

After the wall charge amount adjusting pulses have been applied, a sustain pulse (first sustain pulse) is applied to the row electrode X. The first sustain pulse has a wider pulse width Ta. After the application of the sustain pulse having the pulse width Ta, a sustain pulse having a pulse width Tb is applied to the row electrode Y. Subsequently, the sustain pulse having the pulse width Tb is alternately applied to the row electrodes X, Y. Each of the sustain pulses has the same polarity as the wall charge amount adjusting pulses. The number of times the sustain pulse is applied to the row electrodes X, Y is a number of pulse which has been previously set in accordance with a weight of each subfield.

When set into a lit discharge cell state in a pixel data writing stage Wc, the application of the sustain pulse causes a sustain discharge to occur in a direction indicated by a broken line arrow in FIG. 4 between the row electrodes X, Y.

Since the amount of wall charge formed on the column electrode Z has been reduced due to the application of the wall charge amount adjusting pulses, a discharge is prevented between the row electrode X or Y and the column electrode Z due to subsequent application of the sustain pulse. Therefore, the sustain discharge is stabilized. Also, by applying the row electrodes X, Y with the wall charge amount adjusting pulses having the same polarity and the same voltage at the same timing, reactive power can be limited.

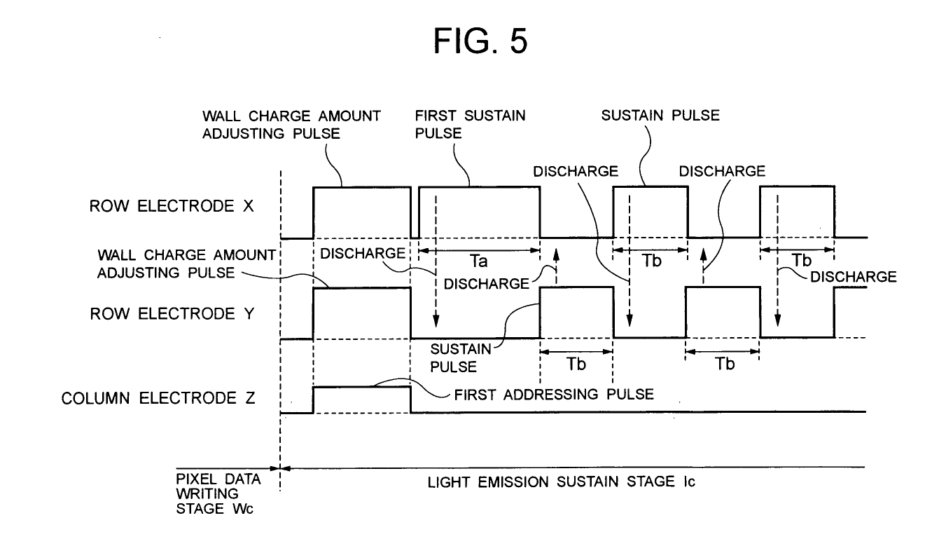

FIG. 5 shows another embodiment of the present invention, representing pulses applied to the respective row electrodes X, Y and column electrode Z in the light emission sustain stage Ic in one subfield, as is the case with FIG. 4. In this embodiment, a first addressing pulse is applied to the column electrode Z simultaneously at a timing at which the wall charge amount adjusting pulses are applied to the row electrodes X, Y, respectively. The first addressing pulse has the same polarity and the same pulse width as the wall charge amount adjusting pulses. Subsequent application of the sustain pulse to the row electrodes X, Y is the same as the embodiment of FIG. 4.

In the embodiment of FIG. 5, a discharge between the row electrode X or Y and the column electrode Z can be weakened by the simultaneous application of the wall charge amount adjusting pulses and first addressing pulse. As a result, a discharge is prevented between the row electrode X or Y and the column electrode Z due to subsequent application of the sustain pulse.

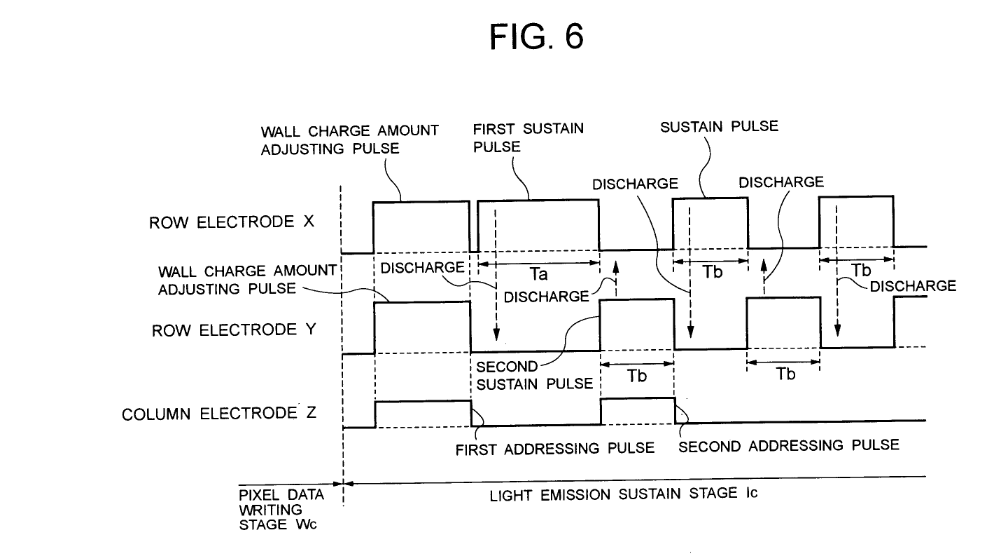

FIG. 6 further shows another embodiment of the present invention, representing pulses applied to the row respective electrodes X, Y and column electrode Z in the light emission sustain stage Ic in one subfield, as is the case with FIG. 4. In this embodiment, the first addressing pulse is applied to the column electrode Z simultaneously at a timing at which the wall charge amount adjusting pulses are applied to the row electrodes X, Y, respectively. The first addressing pulse has the same polarity and the same pulse width as the wall charge amount adjusting pulses. Subsequently, a sustain pulse having a pulse width Ta (first sustain pulse) is first applied to the row electrode X, and then, the column electrode Z is applied with a second addressing pulse simultaneously at a timing at which the row electrode Y is applied with a sustain pulse having a pulse width Tb (second sustain pulse). The second addressing pulse has the same polarity and the same pulse width as the sustain pulse having the pulse width Tb. Subsequent application of the sustain pulse having the pulse width T to the row electrodes X, Y is the same as the embodiment of FIG. 4.

In the embodiment of FIG. 6, a discharge between the row electrode X or Y and the column electrode Z can be weakened by the simultaneous application of the second sustain pulse and second addressing pulse, even if no discharge has occurred between the row electrode X or Y and the column electrode Z due to the application of the wall charge amount adjusting pulses and first addressing pulse. As a result, a discharge is prevented between the row electrode X or Y and the column electrode Z due to subsequent application of the sustain pulse.

The driving method in each of the foregoing embodiments is implemented in a similar manner for all the row electrodes X₁-Xₙ, Y₁-Yₙ and column electrodes Z₁-Zₘ of the PDP 10 in the display device of FIG. 1.

Also, while each of the foregoing embodiments has been described for the case where the present invention is applied to a display device conforming to the selective erasure addressing method, the present invention can be applied similarly to a display device conforming to a selective write addressing method. The reset stage need not be provided in every subfield in the display device conforming to the selective write addressing method.

Further, while in each of the foregoing embodiments, the pulse width Ta of the first sustain pulse is larger than the pulse width Tb of all subsequent sustain pulses, this is not a limitation. The pulse width of the first sustain pulse is only required to be larger than the pulse width of at least one of sustain pulses which are applied after the first sustain pulse. The pulse widths of the sustain pulses applied after the first sustain pulse need not be the same.

In the foregoing embodiments, since the input video signal is a signal of interlaced scanning such as NTSC, the PDP is driven subfield by subfield. When the input video signal is a signal of non-interlaced scanning, the PDP is driven subframe by subframe by dividing a display period of one frame into a plurality of subframes (periods).

According to the present invention described above in detail, the pulse width of the first sustain pulse of sustain pulses applied in the light emission sustain stage is set to be larger than the pulse width of at least one of the sustain pulses applied after the first sustain pulse, and the wall charge amount adjusting pulses having the same polarity as the sustain pulse are simultaneously applied to the respective row electrodes which form a pair immediately before the first sustain pulse is applied, thereby making it possible to prevent an erroneous discharge in the light emission sustain stage.

This application is based on a Japanese Application No. 2003-198255 which is hereby incorporated by reference.

1. A driving method for driving a plasma display panel to produce a halftone image in accordance with an image signal, said plasma display panel having discharge cells at respective intersections of a plurality of row electrode pairs corresponding to display lines and a plurality of column electrodes arranged to cross said row electrode pairs, the method comprising the steps of:
dividing a display period of one field of the image signal into a plurality of subfields,
in each of said subfields, executing
a pixel data writing stage for sequentially applying a scanning pulse to one row electrode of said row electrode pair, and applying pixel data pulses corresponding to the image signal, to said column electrodes in order to generate a selective discharge for setting each of said discharge cells to one of a lit discharge cell state and an unlit discharge cell state, and
a light emission sustain stage for applying said row electrode pairs with a sustain pulse by a number of times corresponding to a weight assigned to each of said subfields in order to generate a sustain discharge only in said discharge cells which are in the lit discharge cell state, and
setting a pulse width of a first sustain pulse applied first of said sustain pulses applied in said light emission sustain stage so that the pulse width becomes larger than a pulse width of at least one sustain pulse of the sustain pulses applied after said first sustain pulse, and simultaneously applying wall charge amount adjusting pulses having the same polarity as said sustain pulses to said respective row electrodes which form a pair immediately before said first sustain pulse is applied.

2. A method of driving a plasma display panel according to claim 1, wherein said column electrode is applied with a first addressing pulse having the same polarity as said wall charge amount adjusting pulses simultaneously with said wall charge amount adjusting pulses.

3. A method of driving a plasma display panel according to claim 1, wherein said column electrode is applied with a second addressing pulse having the same polarity as a second sustain pulse, which is applied at the second time, of said sustain pulses in said light emission sustain stage simultaneously with said second sustain pulse.
